(19) United States
(12) Patent Application Publication
(10) Pub. No.: US 2013/0344455 A1
(43) Pub. Date: Dec. 26, 2013

(54) DENTAL IMPLEMENTS

(71) Applicant: Garrison Dental Solutions, Spring Lake, MI (US)

(72) Inventors: Alex Hull, Hudsonville, MI (US); Derek Gorter, Georgetown Township, MI (US); Robert Anderson, Coopersville, MI (US); Scott Doenges, West Olive, MI (US); Bruce Fredricks, Grand Haven, MI (US); Benjamin Fredricks, Grand Haven, MI (US); Scott Wilde, Grand Haven, MI (US); Daniel J. Riggs, Hamilton, MI (US)

(21) Appl. No.: 13/912,052

(22) Filed: Jun. 6, 2013

Related U.S. Application Data
(60) Provisional application No. 61/656,129, filed on Jun. 6, 2012.

(51) Int. Cl. A61C 5/12; A61C 13/15

(52) U.S. Cl. CPC A61C 5/125; A61C 19/003
USPC 433/29; 433/39

(57) ABSTRACT

A matrix ring comprising a ring body and a pair of opposing tips mounted to the ends of the ring body. Each of the tips may be movably coupled to the ring body about an axis of rotation. Optionally, or alternatively, the tips may be removably mounted to the ring body. For example, the ring body may include a pair of opposed spaced apart ends each with a tine mounted at each end. Further, at least a portion of the matrix ring may be formed from a bulk amorphous alloy.

This application claims benefit to U.S. provisional patent application Ser. No. 61/656,129 filed Jun. 6, 2012 by applicant Scott Doenges and is entitled TOOTH RESTORATION IMPLEMENTS, the complete disclosure of which is hereby incorporated herein by reference.

### TECHNICAL FIELD AND BACKGROUND OF THE INVENTION

The present invention generally relates to dental implements, and more particularly, to a matrix ring that can be used to separate teeth and, further, to hold a matrix band in place around a tooth when the tooth is to undergo restoration.

Typically, when tooth decay occurs near the outer edges of a tooth, there is often insufficient tooth structure remaining to support the filling material while it is hardening. To overcome this problem, a thin band (“matrix band”) is positioned about the tooth and secured to the tooth to provide the required support for the filling material. With the band in place, the filling material can be applied into the cavity being filled and then formed into the desired shape.

To achieve the desired anatomy, it is often necessary to separate the tooth undergoing repair from the immediately adjacent teeth. This is typically accomplished through the use of open ended rings with downwardly projecting tines, the ends of which are placed on opposing sides of the region between the affected tooth and the adjacent tooth, which require separation. Use of such a device requires opening of the ring, which separates the opposing tines so that they can be positioned on opposing sides of the teeth, and then release so that the tines then generate sufficient force to separate the teeth.

### SUMMARY OF THE INVENTION

The present invention provides several matrix rings that include adjustable tips, which adjustability allows the matrix rings to better conform to a wide range of tooth configurations and, therefore, adapt to varying tooth configurations and conditions.

In one embodiment, the tip or tips are configured to pivot about the occlusogingival (vertical) axis.

In another aspect, the tip or tips of the matrix ring are allowed to swivel about multiple axes. For example, the tip (or tips) may have limited motion about the occlusogingival and buccolingual axes, but fixed about the mesiodistal axis.

The motion along some axes may be limited or even prevented. For example, the amount of pivot may be limited in a range of about 0-75 degrees, 0-65 degrees, or about 0-55 degrees. The tip may be spring loaded (through a spring or material properties) to return to its nominal position when unloaded.

In any of the above, the tips of the matrix ring may be designed such that they can be removed and/or replaced. The tips may be designed such that they are able to be assembled and disassembled multiple times. For example, this may be accomplished via a snap-fit design. Optionally, the snap fit design may allow for the assembly force to be significantly lower than the disassembly force. Alternately, the tips may be designed such that they are destroyed once they are disassembled.

In another embodiment, a matrix ring system is provided that includes at least two rings, one having a distal leg that is shorter in the occlusogingival direction, the other shorter on the mesial leg. The shorter leg is optionally designed such that it can be placed above a rubber dam clamp, while still adapting and maintaining to the tooth anatomy.

According to yet another embodiment, a matrix ring includes a ring body which attaches to the tip near the gingival margin. Alternately the ring body attaches to the tip offset from the center of the tip to improve visibility.

In yet another for, a matrix ring is formed completely or partially out of a bulk amorphous alloy. For example, the ring body may be formed from the bulk amorphous alloy with integrated tip geometry to engage the teeth, and optionally with an added soft material to adapt to the teeth.

An embodiment is also provided with a bulk amorphous alloy ring body with tips made of at least one additional material, for example, soft material for tooth adaptation.

Alternately, a matrix ring may be formed with a bulk amorphous alloy ring body attached to bulk amorphous alloy tips with integrated retention features, with or without a second material.

In yet another form, a matrix ring includes integrated features that allow it to be opened, placed, and removed by hand, without the need for any forceps, or other instrument.

In other aspects, the present invention provides a matrix ring with removable and replaceable tips. Optionally, a kit may be provided with multiple different size and shaped tips.

### BRIEF DESCRIPTION OF THE DRAWINGS

FIG. 1 is a partial perspective, exploded view of a matrix ring of the present invention;

FIG. 1A is a similar view to FIG. 1 showing the tip mounted to the end of the ring body;

FIG. 2 is a partial perspective, exploded view of a matrix ring of the present invention;

FIG. 2A is a similar view to FIG. 2 showing the tip removed from the end of the ring body;

FIG. 3 is a side elevation view of two matrix rings of the present invention, shown positioned about adjacent teeth and further with one of the matrix rings adapted for positioning above a rubber dam clamp;

FIG. 4 is a side elevation view of another embodiment of a matrix ring of the present invention;

FIG. 5 is a plan view of the matrix ring of FIG. 4;

FIG. 6A-6C are side elevation views of another embodiment of a matrix ring of the present invention;

FIG. 7 is a perspective view of another embodiment of a matrix ring of the present invention;

FIG. 8 is another perspective view of the matrix ring of FIG. 7;

FIG. 9 is another enlarged view of the tips of the matrix ring of FIGS. 7 and 8 with a modified tip;

FIG. 10 is a similar view to FIG. 9 illustrating a matrix ring incorporating a curing light;

FIG. 10A is a similar view to FIG. 10 illustrating a matrix ring with a self-contained curing system; and

FIG. 11 is a perspective view of a matrix ring with forceps to facilitate placement.

### DETAILED DESCRIPTION OF THE PREFERRED EMBODIMENTS

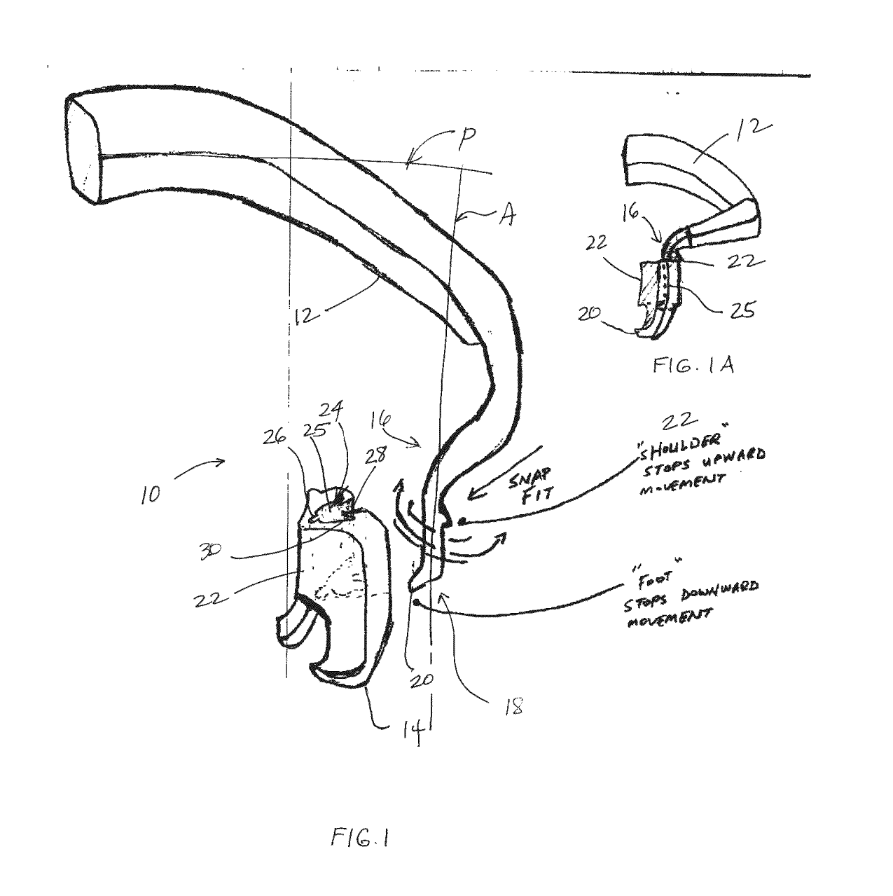

Referring to FIG. 1, a dental implement in the form of a matrix ring is identified by the numeral 10. Matrix ring 10 includes an open ended ring shaped body 12 and opposing tips 14 (only one shown). Ring body 12 is sized and configured so that when the open ends are separated, for example, by forceps (such as described in U.S. Pat. No. 7,165,970 commonly owned by Garrison Dental Solutions, Inc.), tips 14 may be placed on opposed sides of adjacent teeth and then when released tips 14 will be urged toward each other (by the spring force generated by ring body 12) and apply a separation force to the adjacent teeth and further hold a matrix band against the tooth being restored.

Suitable matrix bands are disclosed in U.S. Pat. App. Pub. No. 2011/0070555 A1 published to Anderson et al. and U.S. Pat. No. 5,607,302 issued to Garrison et al., the entire disclosures of which are hereby incorporated by reference in their entireties, also commonly owned by Garrison Dental Solutions, Inc. Though it should be understood that matrix ring 10 may be configured for use with other matrix bands.

As would be understood by those skilled in the art, tips 14 press against the interproximal space between the two adjoining teeth and against the teeth themselves to provide a support to the band while the tooth is undergoing repair.

Referring again to FIG. 1, ring-shaped body 12 comprises a hoop-like member formed, for example from metal, including the bulk amorphous alloy described below, or a combination of metal and plastic, with two opposing spaced apart ends 16 (only one shown), which may touch or be separated by a distance from each other that is less than the width of a tooth, for example. Although only one end is shown, it should be understood that the other end may be a mirror image of the end shown, or may have another configuration as more fully explained below. Further, while illustrated with a generally round hoop-like configuration, ring body 12 may also comprise a square hoop-like configuration, an elliptical hoop-like configuration, a hexagonal hoop-like configuration, or other arbitrary hoop-like configurations. Further, the ring body further may include a secondary ring, for example, which is molded over a portion of the ring body, such as disclosed in copending U.S. patent application entitled MATRIX RING FOR TOOTH RESTORATION, Ser. No. 13/781,252, filed Feb. 28, 2013, which is incorporated by reference in its entirety herein. Suitable tips are also described in U.S. patent application entitled MATRIX RING FOR TOOTH RESTORATION, Ser. No. 13/781,252, filed Feb. 28, 2013.

As best understood from FIGS. 1 and 1A, end 16 is configured to mount tip 14 onto ring-shaped body 12 and, further, optionally releasably mount tip 14 to body 12. In the illustrated embodiment, tip 14 is mounted with a snap-on or snap-fit connection formed by end 16 and tip 14, described more fully below. In this manner, tips may be removed for replacement with tips of various designs. This allows a user to customize the matrix ring for each client or application. Further, in some cases, the tip is the most frequent wear point on the matrix ring; therefore, a user may be able to purchase additional tips to replace the old ones themselves and continue using the matrix ring.

Additionally, matrix rings 10 may be provided with a number of tips of varying sizes and shapes to allow on-the-job customization using a single ring body. For example, the tips may be mounted to a carrier by a quick release mechanism, including a frangible web, so that the tips may be decoupled from carrier for use with the ring body. Alternately, the carrier may have an engagement structure which releasably engages a corresponding engagement structure on the tip so that the tip can be recoupled to the carrier after use for storage and later use. Ideally the carrier and the tips together can be cleaned as an assembly. It should be understood from the present description that ring body may therefore have different tips mounted to its respective ends so as to further customize the matrix ring.

Further, tip 14 is optionally movably mounted to end 16 so that the tip can be adjusted to adapt to the particular tooth (teeth) configuration. In one aspect, tip 14 is rotatably mounted to end 16 so that tip 14 can pivot and adapt, for example, to the lingual and buccal sides of the tooth being restored. This pivoting motion allows the tip to center itself during placement so that both mesial and distal retention features are able to engage and properly secure the ring against the teeth.

As best seen in FIG. 1, each end 16 includes a downwardly depending tine 18. Each tine 18 is generally vertically oriented relative to ring body 12 (as viewed in FIG. 1) and includes a flange or foot 20 and an upper shoulder 22 spaced vertically above flange 20, which together define there between a connection portion, for example a generally cylindrical portion or section about which tip 14 may be rotatably mounted, with flange 20 and shoulder 22 providing stops for tip 14 once tip 14 is mounted to tine 18 to prevent unintended upward or downward movement of tip 14.

Referring again to FIG. 1, tip 14 comprises a wedge-shaped body or wedge 22 and includes a vertical (as viewed in FIG. 1) passageway 24 for receiving tine 18. Passageway 24 includes a central generally circular portion 25 and a channel 26 which extends outwardly from circular portion 25 to form a spring so that circular portion can open to receive tine 18. Further, the length of passageway 24 is sized so that when tine is inserted into passageway 24, flange 20 will be located beyond the lower end of passageway 24 to thereby form a stop to prevent wedge 22 from moving downward relative to tine 18 (or vice versa, i.e. prevent tine 18 from moving upward relative to wedge 22).

In a similar manner, shoulder 22 is spaced above flange 20 so that it generally rests on or is in close proximity to the upper side (as viewed in FIG. 1) of wedge 22 when tine 18 is mounted in passageway 24 so that it too acts as a stop to prevent downward upward movement of wedge 22 relative to tine 18 (or vice versa).

In addition, in the illustrated embodiment central section 25 of passageway 24 is also open to the inwardly facing side (as viewed in FIG. 1) of wedge 22 through a vertical channel 28 which is bounded by a pair of ribs 30, which also form springs and flex to allow tine 18 to be inserted into channel 28. But once tine 18 is fully inserted into central portion 25, ribs 30 rebound to trap tine 18 in passageway 24 to thereby form a snap-fit connection and form a snap-on arrangement between ring body 12 and tip 14. Alternately, passageway 24 may be closed (without channel 28) but sized to allow tip 14 to be slid onto tine 18 with flange 20 adapted to flex or bend so that when fully inserted, flange 20 may restore itself back to its uncompressed state and therefore act as a stop.

In addition, the snap fit design may allow for the assembly force to be significantly lower than the disassembly force. For example, the ribs may be configured to compress inwardly with a lower force that they need to be separated to let tine 18 to be released from passageway 24. Further, the snap feature(s) in the tip may be configured to provide sufficiently high disassembly force to keep the matrix ring intact during the procedure.

In alternate embodiment may include a male tip 18 and a female ring body 24.

Thus, in each case, when tip 14 is mounted to body 12, tip 14 can rotate about end 16 and, further, more specifically about tine 18 about the vertical axis A that extends through tine 18 and also which is generally perpendicular to the plane P, in which at least a portion of ring body 12 lies.

Optionally, the range of motion of tip 14 or wedge 22 may be limited. For example, it may be desirable to limit the angle range of motion from about 0° to 75°, from about 0° to 65° and optionally from about 0° to 55°. To limit the range of motion, the upper and/or lower facing sides of wedge 22 may include projections, such as ribs or the like, against which shoulder 22 and/or flange 20 abut when moving to the outer limits of the desired rotation. Alternately, the limited range of motion can be achieved by the shape of the passageway 24 and/or the cross-section of tine 18 or by a member inserted between wedge 22 and tine 18.

Alternately, the pivot joint may be formed by a ball and socket configuration, i.e. the ball formed on the tine and the socket formed on the wedge or vice versa, which could be configured to limit the motion primarily along the occlusoginsival axis. Controlling motion along the axis could be achieved by keying, for example, the ball in certain directions, or limiting the motion of the ring extending from the ball feature within a slot in the tip (or visa-versa). In yet another variation, the tip may be over molded on the tip but still allowed to rotate, for example, in ranges noted above.

In addition, tip 14 may be biased to return the tip to a nominal or “home” position. For example, tip 14 may include a spring member or have a material, for example, inserted or over molded onto one or more of the mating surfaces, that urges the tip to its home position but which still allows the tip to rotate as described above.

Further, the tips may be removed and replaced multiple times. Alternately, the tips may be configured for a single use. For example, a portion of tip 14 may be configured to break when tip 14 is removed to assure that it is not reused. For example, a frangible section or member may be formed in passageway or adjacent passageway, such as ribs 30.

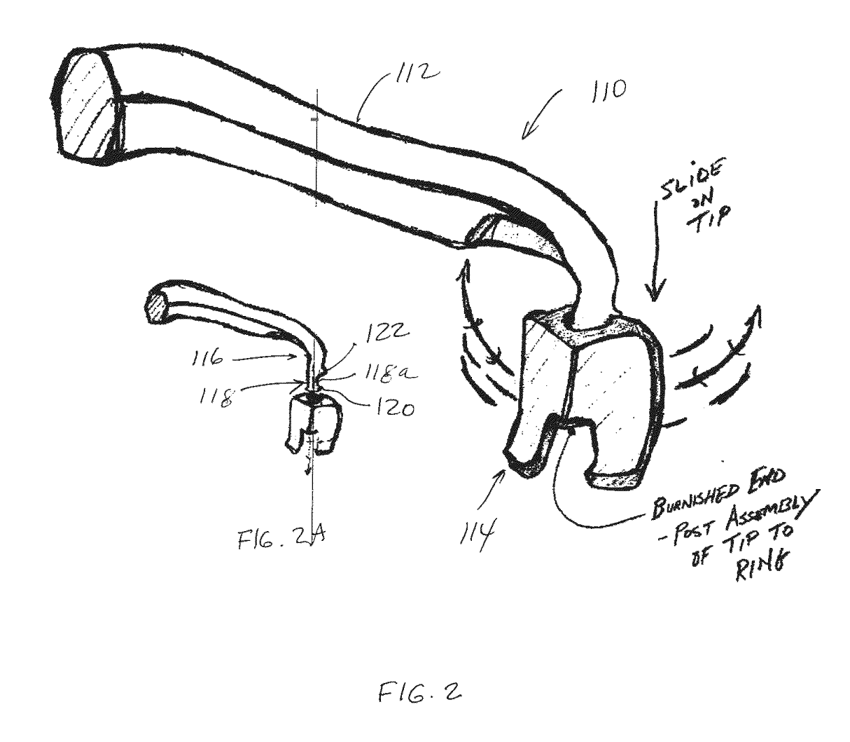

Referring to FIG. 2, the numeral 110 designates another embodiment of a matrix ring of the present invention. Matrix ring 110 (only one half is shown) is similar to matrix ring 10 and includes a ring body 112 and two tips 114 (only one shown), which are mounted to the spaced apart ends 116 of ring body 112. In the illustrated embodiment, one or more of the tips 114 may be non-removable. For example, the tip or tips may be over molded about tine 118 about its cylindrical portion or section 118a, which is also located between a lower flange or foot 120 and an upper shoulder 122, or assembled prior to forming or attaching flange 120. Flange 120 and shoulder 122 also act as stops, in the vertical direction (as described previously) and optionally also about the vertical axis to limit the rotation of tip 114.

Alternately, as noted, tip 114 may be mounted, for example, by sliding onto tine 118 before the formation of flange 120. For example, flange 120 may be formed either by the material forming tine 118, for example, by burnishing the end of tine 118 or may be post attached, and also therefore comprise a different material than tine 118. Also as described above, the pivotal or rotational joint may be formed by a ball and socket arrangement.

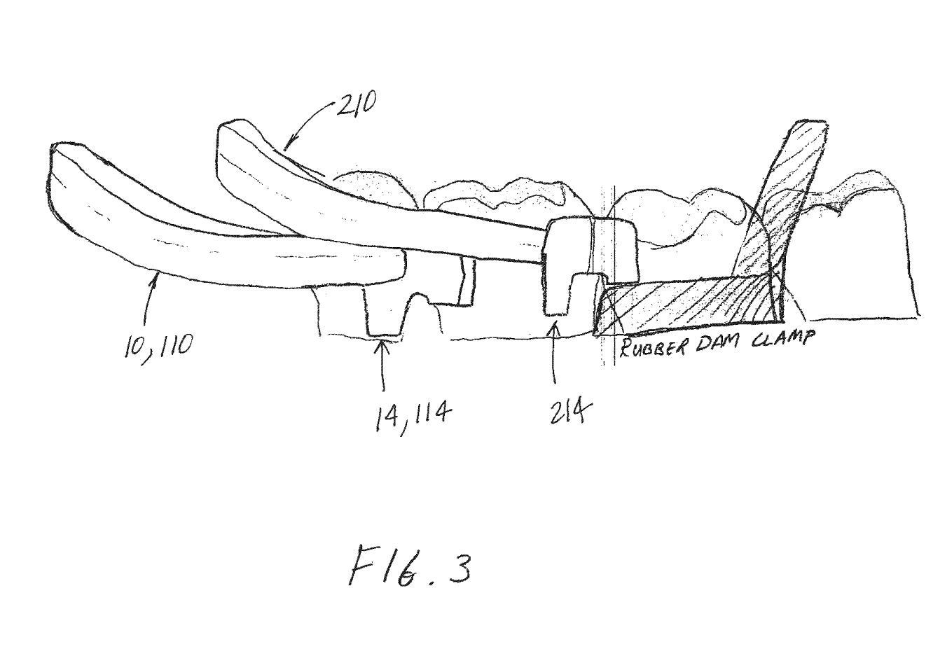

Referring to FIG. 3, rubber dams are recommended for use in class II restorative procedures. Rubber dams isolate the working area & prevent aspiration of materials and are held in place with rubber dam clamps that clamp around the gingival margin of the tooth. However, until now, many matrix rings on the market cannot be placed on top of these rubber dam clamps; otherwise they will slip off of the tooth, or fail to locate properly. The numeral 210 generally designates yet another embodiment of a matrix ring of the present invention which is adapted for use with rubber dam clamps.

Matrix ring 210 may be formed in a similar manner to matrix rings 10 or 110 or may be formed with a fixed tip. In the illustrated embodiment, matrix ring 210 includes one of more of the tips to be formed, such as shown and described in reference to tips 14 or 114, but with a shortened tip along the mesial direction but with the other tip longer in the occlusogingival direction. In this manner, the shorter tip 214 can be placed above a rubber dam clamp, while still adapting to the tooth anatomy and maintaining the matrix band against the tooth. The tips of the rings are optionally designed with retentive barb features (see U.S. patent application entitled MATRIX RING FOR TOOTH RESTORATION, Ser. No. 13/781,252, filed Feb. 28, 2013) to allow the tip to retain itself against the tooth while sitting above the gingival margin.

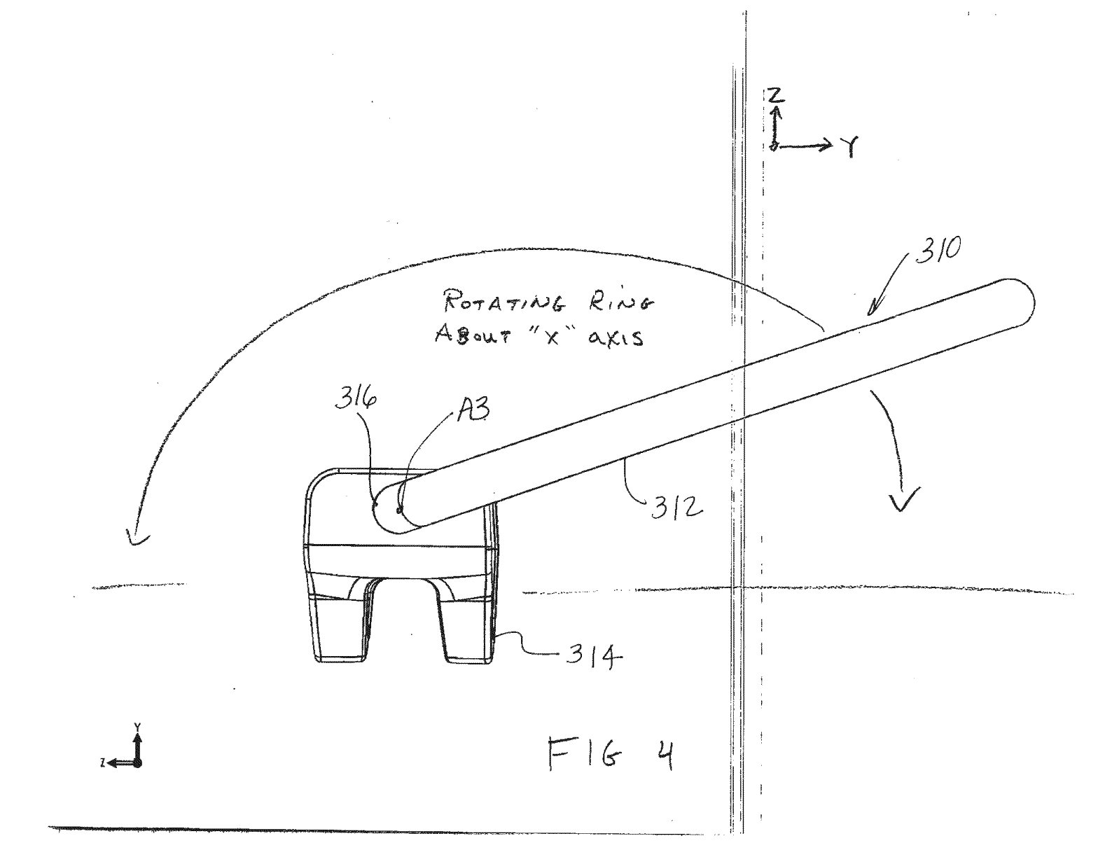

Referring to FIG. 4, the numeral 310 designates yet another embodiment of a matrix ring of the present invention. Matrix ring 310 also includes a ring body 312 with two spaced apart ends 316 (only one shown) and with a tip 314 (only one shown) mounted to each of the respective ends near the gingival margin and, further, optionally mounted for movement about multiple axes. In the illustrated embodiment, tips 314 are pivotal mounted to ends 316 about an axis A3 that extends outwardly from the page in FIG. 4 and that lies or is parallel to the plane P3 in which ring body lies depending on the bed of the ends of ring body 312. In this manner, once the tip is placed between two teeth, the ring body may be pivoted about the pivot axis. Similar to the previous embodiment, the range of motion of ring body 312 may be limited.

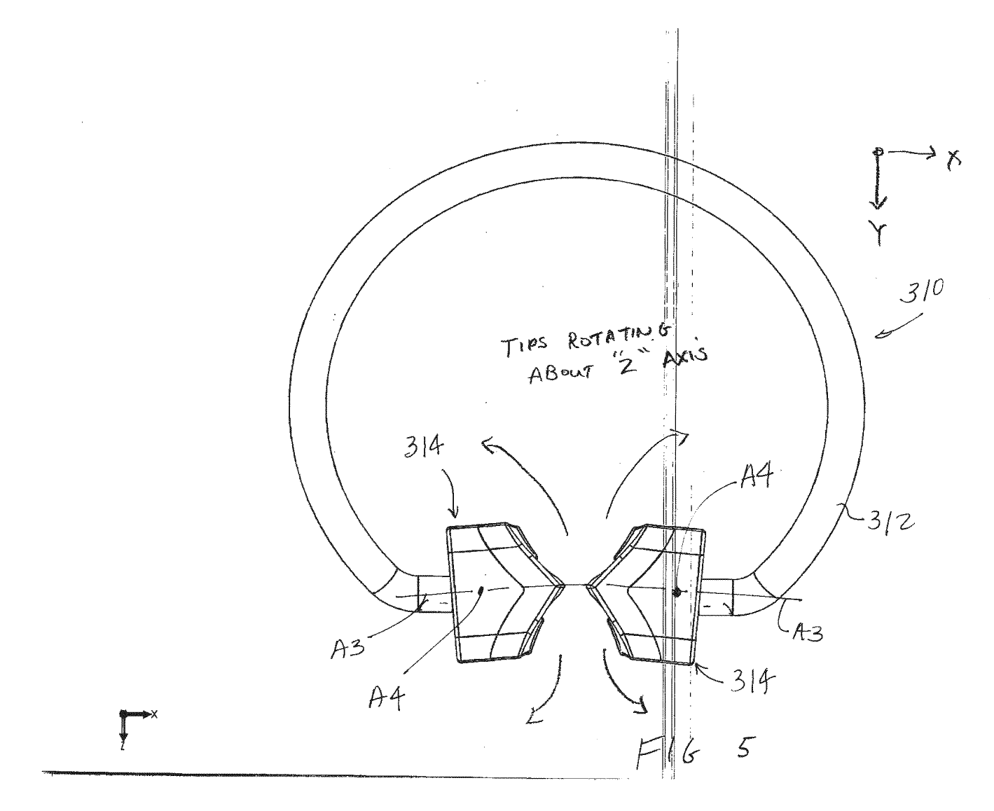

Referring to FIG. 5, each tip 314 may also be mounted for pivotal movement about an axis A4 that projects outwardly from the page in FIG. 5, and therefore may be angled, including orthogonal, to the plane P3 but which are spaced from each other. Again, the pivoting motion allows the tips to center themselves during placement so that both mesial & distal retention features are able to engage & properly secure the ring against the teeth. Additionally, motion along the buccolingual axis may further allow the tip to properly locate interproximally for ideal adaptation & retention against both mesial & distal teeth. Motion along the buccolingual axis may be detrimental to the placement & adaptation of the ring, so this may be fixed.

In one embodiment, tips 314 may be configured to have limited motion about the occlusongingival and buccolingual axes, i.e. limited between the range of motion examples given above, but may be fixed about the mesiodistal axis. Similar to as described above, tips 314 may also be biased to return to a “home” or “nominal” position when unloaded.

Again the ability the tip(s) to rotate about one or more axes allows the tip (or tips) to adjust and properly conform to most, if not all, tooth anatomies.

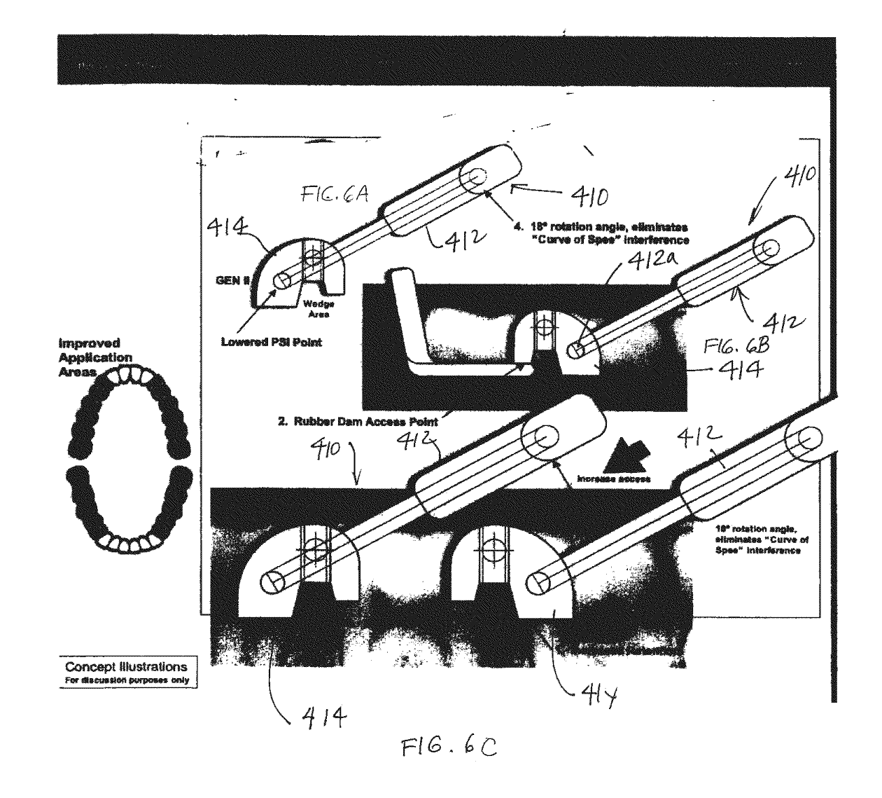

Optionally, as best seen in FIG. 6, in another embodiment of matrix ring 410, ring body 412 may be pivotally mounted to tips 414 at a point offset and further lower than as shown in reference to matrix ring 310. This offset and lower connection point 412a provides an attachment point for the ring body closer to the gingival margin. Most matrix rings on the market currently have an attachment point close to the occlusal margin. However, applying the force lower on the tooth distributes more force to the retention features below the infrabulge of the tooth. This lower distribution of force should increase the retention of the ring to the tooth, preventing slip-off or movement during the restorative procedure. Further, most matrix rings need to attach interproximally (center of the tip) in order to properly retain the matrix band and adapt to the anatomy of the tooth. Because most rings have an opening at the gingival margin for wedge placement, the only remaining location is the occlusal margin (top).

In one form, at least the tips of matrix ring 410 may be formed using a material that is rigid enough to allow the attachment of the ring body to the tips to distribute the force interproximally. This rigid tip material may be a bulk amorphous alloy.

Bulk amorphous alloys, as the name implies, have an amorphous molecular structure, rather than the crystalline structure of traditional metals. The molecular structure of traditional crystalline metals is made up of grains of molecules, separated by grain-boundaries. Crystalline structure also has inherent defects, called dislocations, in their structure. Bulk amorphous alloys have a tightly packed, unorganized, glass-like structure that lacks grains or dislocations. It is this key difference that allows the unique combination of properties that is ideally suited for use in matrix rings.

The presence and creation of dislocations in crystalline metals are what allow plastic deformation to occur. Dislocations limit the strength of the material. Bulk amorphous alloys do not have dislocations; therefore, they have a higher yield strength and ultimate strength than comparable crystalline alloys, making them both very strong and very elastic.

The amorphous structure is tightly packed, with a low free volume, which allows some bulk amorphous alloys are able to be cast into complex shapes without the traditional drawbacks of casting (e.g., weakness, brittleness, rough surface finish). The low free volume also results in a low shrink rate during casting, which allows for very tight manufacturing tolerances which greatly simplify the soft-face over-molding process.

Some traditional metals experience corrosion at their grain-boundaries. Bulk amorphous alloys lack grain-boundaries; therefore, they are usually more resistant to corrosion that traditional metals.

Using a tip material and design with sufficient rigidity to distribute force interproximally and to the opposite side of the tip allows the attachment point to be located at the gingival margin on the distal or mesial side. Alternately, the ring body may attach to the tip in multiple points per side, for example, at the gingival margin of both the distal and mesial side.

Additionally, in a similar manner to matrix ring 310, ring body 412 may be pivotally mounted to tips 414 so that ring body 412 may be pivoted, for example, over a limited range of motion, for example, from about 0° to 25°, 0° to 20°, and optionally from about 0° to 18° from horizontal. And as noted above, ring body 412 may be mounted to tips 414 at the gingival margin on either the distal side or the mesial side.

Alternately, ring body 412 and tips 414 may be configured to provide multiple connection points, for example, at the gingival margin of both the distal side and mesial side.

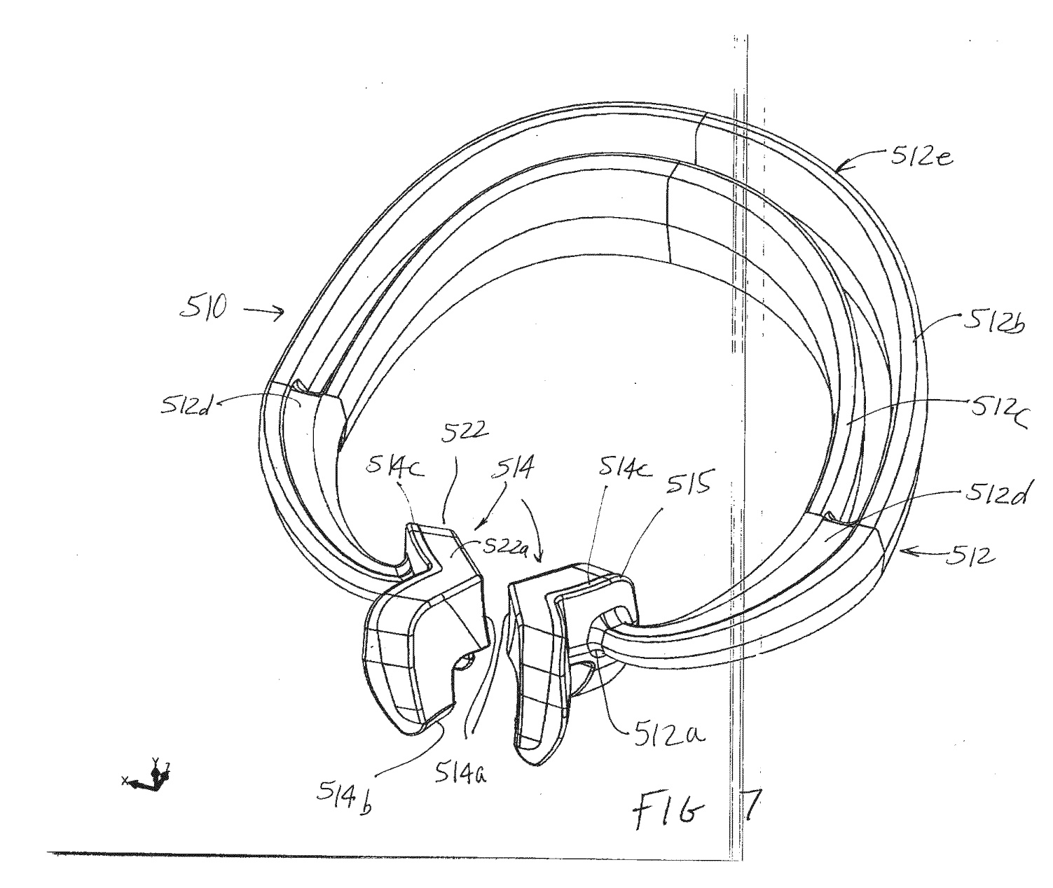

Referring to FIGS. 7-9, the numeral 510 generally designates another embodiment of a matrix ring of the present invention. As will be more fully described below, matrix rings 510 may be formed from a material that not only increases the strength of the ring body (512) but also the elasticity of the matrix ring. In addition, the material allows the matrix ring to be less bulky and allow better access and/or working spaces. Additionally, in one form, the material forming the ring body and tip bases (described below) to be finished in a manner to form a reflective surface, which may be used to increase visibility of the working area and the tooth or teeth undergoing restoration.

In one form, matrix ring 510 is at least partially formed from a bulk amorphous alloy or bulk metallic glass, such as Liquid Metal.

The current state of matrix rings is such that they are either able to achieve high strength or high elasticity, but not both. Rings made primarily of spring steel offer high strength, but moderate elasticity, needing an extra body component to make the ring sufficiently elastic (e.g., plastic over-molds). Rings made of titanium or nickel-titanium offer high elasticity, but moderate strength. With the size and geometry constraints placed on matrix ring designs by the tight, anatomically-varying working area (the mouth), the materials currently used in matrix rings are not able to achieve both targets.

All rings on the market permanently deform and lose strength over each procedure, until they eventually are too stretched-out or weak to properly function. However, with a matrix ring body formed from bulk amorphous alloy, its unique combination of high strength and high elasticity makes an ideal spring material. By utilizing these properties, the Applicant believes that they can make a matrix ring with superior separation and retention force, while being smaller than rings with similar force made from standard materials. As noted above, smaller rings are desirable because they take up less space in the mouth and leave additional working area. Smaller rings also allow more flexibility in placement and greater applications.

Bulk amorphous alloys have a very high surface harness and are resistant to corrosion, which properties make bulk amorphous alloys better suited to dental use than the standard materials used in matrix rings, because matrix rings are subject to a variety of highly corrosive materials and undergo demanding sterilization and cleaning processes. It is believed that bulk amorphous alloys can withstand these processes while maintaining their form, fit, and function better than standard materials.

This is in part because bulk amorphous alloys are able to be manufactured in a net-shape process to create very thin, detailed features in a single step. This allows for matrix rings that have small features for retention, location, or separation, which are stronger, more durable, and more effective. It may also be used to create very thin, strong walls that decrease the overall size of the ring and improve visibility in the working area. If desired, it may be produced such that it does not have the sharp edges or rough surface that may be created in other metal processes such as casting, stamping, or machining.

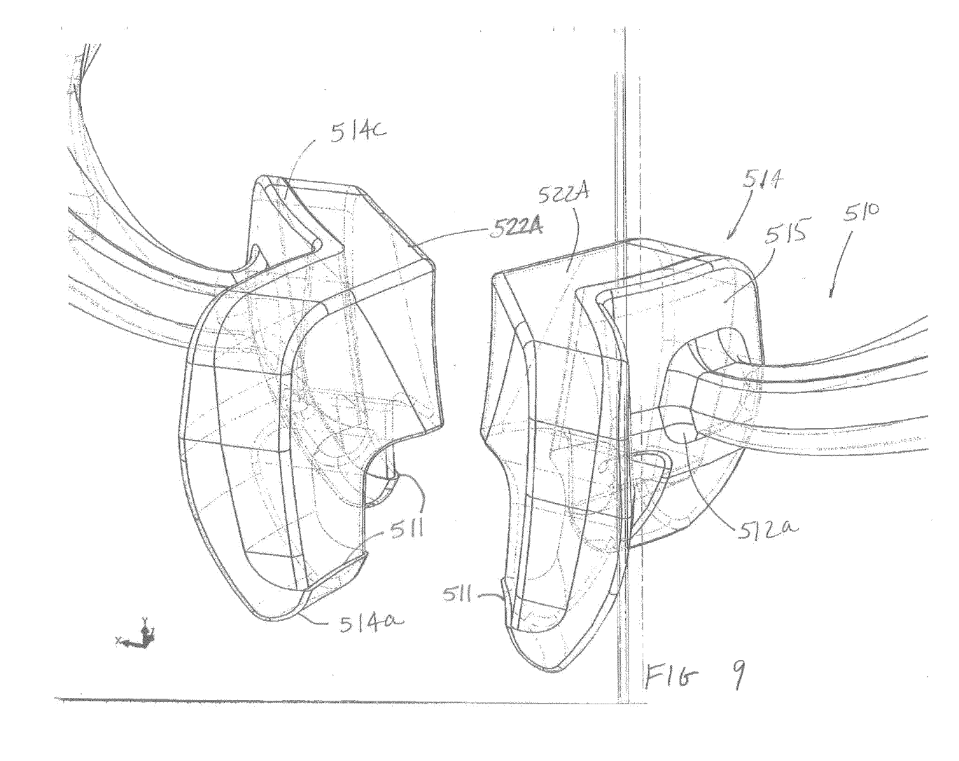

Consequently, matrix ring 510 may be manufactured to provide sharp, clean edges to be produced in a single, net-shape process when desired. For example, matrix ring 510 may be formed with an anatomically contoured retentive edge 511 (FIG. 9) on each tip (and further on both sides of the tip) that is designed into a bulk amorphous alloy matrix ring tip. Using standard (prior art) materials, creating these features would either require a molded plastic tip, whose edge would go dull over the course of use, or a secondary machining operation on a hard metal tip, which could be a prohibitively expensive manufacturing process. Further, a bulk amorphous alloy ring may be over-molded with a softer material to create other desirable features (such as a soft, adaptable face).

In addition, with the amorphous alloy construction, matrix ring 510 has been found to exhibit significantly enhanced performance. For example, the matrix ring shown in the attached figures has been found to exhibit the same strength after being opened to 10 MM (distance between the tips) and allowed to come back to its natural condition. Further, the matrix ring was opened to 10 MM between for 100 cycles, 200 cycles, 300 cycles, 400 cycles, and 500 cycles and the strength after each of these the cycles were the same-ideal for separating the teeth interproximally. Additionally the distance between the tips (permanent set-terminology for springs) did not measurably change from the initial 100 cycles through 200, 300, 400, and the 500 cycles. Thus when made of an amorphous alloy, the matrix ring can last hundreds of cycles while maintaining its initial strength and no permanent set.

Bulk amorphous alloys can be produced in net-shape processes, similar to casting or molding. They may also be machined, unlike some plastics, or maybe cast with integrated features that provide a mechanical lock to the soft-face once over-molded. These features may be, but are not limited to: thru-holes, key-hole or dove-tail slots, or textured surface.

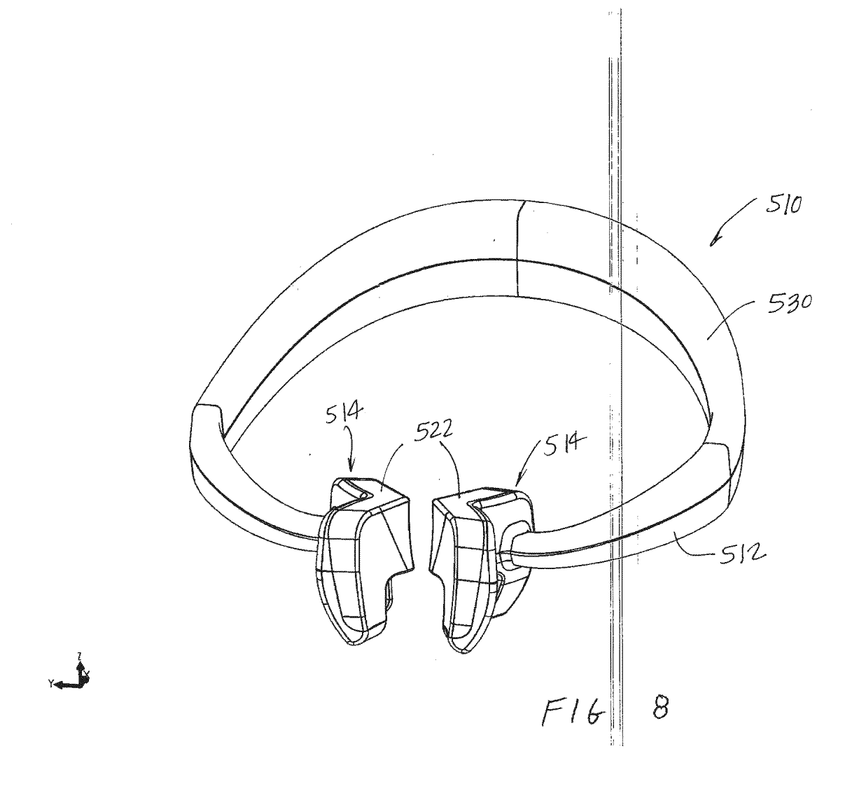

Referring again to FIGS. 7-9, optionally, matrix ring 510 includes a ring body 512 and tips 514 that are both formed from a liquid metal or a bulk amorphous alloy. As best seen in FIGS. 7 and 8, tips 514 may be integrally formed with ring body 512. For example, each tip may be formed form a plate-like structure 515 with a back side joined or formed with the ends of the ring body and an outwardly facing side for optionally receiving a soft face. Further, the outwardly facing sides may each be formed with a mechanical lock to interlock with the soft face. For example, optionally, each tip 514 may be coated or over molded or otherwise provided with a soft material, for example, in the form of a pad 522, which material is selected so that it at least substantially conforms to the center of the tooth. However, it should be understood that the soft material may be omitted.

For example, a suitable material for forming pads 522 includes an elastomer, such as a silicone material having, for example, a Shore A durometer of approximately 50 (while other materials and hardnesses are contemplated). In the illustrated embodiment, tips 514 are formed in a generally V-shaped configuration with an apex 514a, which as would be understood, may be formed by the pad or the base metal material forming tip 514. Apex 514a is oriented for facing the apex on the opposed tip so that when placed around a tooth, the apexes extend into the interproximal space between the two adjacent teeth for separating the teeth as described above.

As noted above, ring body 512 is connected or formed at a fixed connection 512a with each tip offset from the apex, which provides for enhanced visibility of, including, for example, the wedge that is typically placed between the adjacent teeth.

In addition, because of the strength of the material forming tips 514, the thickness of tips 514 may be reduced, for example, into a range of about 0.2 to 2 mm. Again, with the reduced tip thickness visibility, as well as access to the working area, is enhanced.

When provided with pads or a coating, tips 514 are formed with an edge 514b that forms a ledge or shelf to provide support to pad 522. However, to further facilitate visibility, the top edge of tip 514c may terminate in the same plane as, or at least does not over hang, the top edge 522a of pad 522. As will be more fully described below, when pad 522 is formed from a transparent material, a user may have even more enhanced visibility.

As best seen in FIG. 7, ring body 512 may be formed by two or more hoop-like members 512b and 512c, which are then joined together by webs 512d (for example during molding or casting) over at least a portion of the hoop-like members at least adjacent their ends where they are joined with or formed with tips 514. Intermediate discrete webs (not shown) may also be provided, for example, at the base 512a of ring body 512. In this manner, ring body 512 is lighter and further exhibits greater spring properties than a solid cross-sectioned spring body.

As best seen in FIG. 8, matrix ring 510 may also include a plastic body over molded over ring body 512.

As an alternative, and as best seen in FIG. 9, matrix ring 510 may incorporate transparent or translucent or pads 522A or pads with transparent or translucent portions in place of the non-transparent or non-translucent pads 522. Transparent or translucent pads can facilitate viewing of the tooth, matrix band and the filling material.

In addition, with a transparent (or translucent) pad, matrix ring 510 may incorporate a curing light emitting source or curing light, such as an LED, for directing light into the filling material. For example, the curing light may be in the tip, such as in the pad, or in the ring body, with the light passing through the tip or soft face though an opening or openings or spaces in the tip and/or soft face, through a light pipe in the tip and/or soft face or through a transmissive portion of the pad or soft face, such as could be formed by the transparent or translucent portion of the pad or soft face.

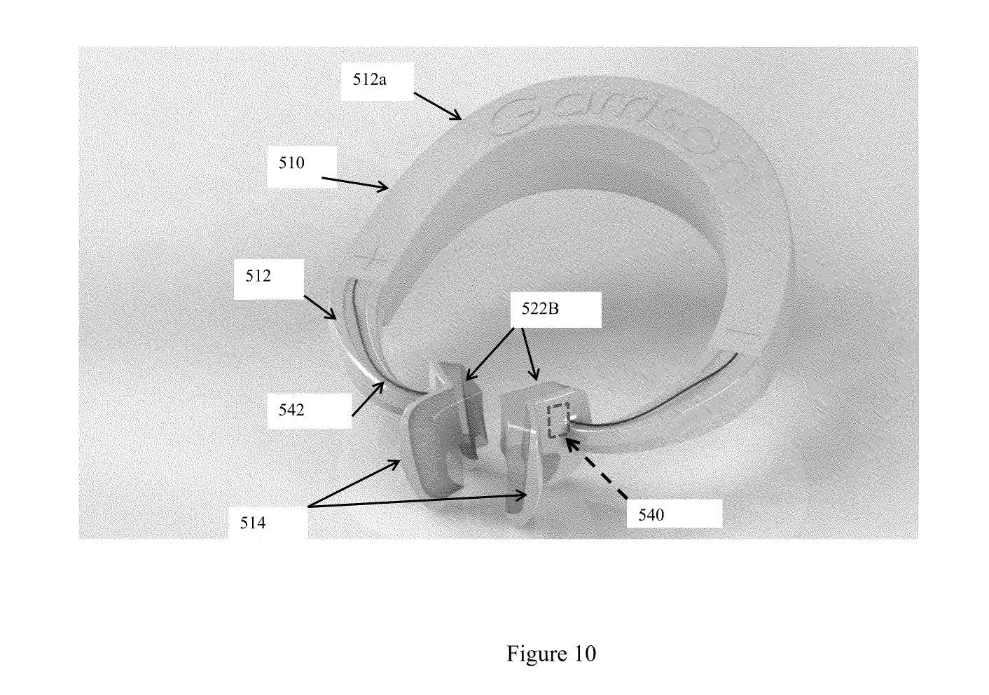

Referring to FIG. 10, matrix ring 510 alternately may incorporate pads 522B, which are also transparent or translucent to allow the curing light to pass through into the restoration. The tips could also be formed with light-piping, or some form of ports to aim the curing lights through the pads or from the pads into the restoration area.

In one embodiment, the curing light(s) may be integrated into the matrix ring and attached to an external power source (such as shown in FIG. 10). For example, the curing light (e.g. LED) may be located in one or both tips 514, which are coupled to a power source, such as supplied by wiring that may extend into ring body 512 and thereafter either exit for coupling to a battery or couple to a connector, such as a socket, formed on ring body for coupling to the external battery.

In another embodiment, the curing light(s) and power source may be integrated into the matrix ring (such as shown in FIG. 10). For example, the curing light (e.g. LED) 540 may be located in one or both tips 514, which are coupled to wiring 542 that extends from the light into ring body 512 and further, for example, into the base 512a of ring body 512, which for example may be covered or formed by plastic (as described above), but which has a compartment for holding a battery. Further, the battery may be rechargeable and may include an inductive coil for charging by an external inductive coil located externally of the matrix ring so that matrix ring may be simply placed near the external inductive coil for recharging. For example the recharging inductive coil may be located in a pad on which the matrix ring and other matrix rings can be placed for recharging.

Alternately, the tip or tips may be formed with a holder for the curing mechanism, such as a LED. Additionally, the holder may comprise a pivotal holder, for example, so that the curing mechanism can be moved from a position where it is not over the filling to a position where it extends beyond the tooth facing surface of the tip so that it is at least partially, if not fully, positioned over the filling to move the curing mechanism closer to the filling. For example, the holder(s) may be pivotally mounted to the top of the respective tip about an axis general parallel to tip's apex so that the holder can move from a first position where the holder does not interfere with the matrix ring's placement, for example, either over the upper edge of the tip (but not extended beyond the tip and therefore not over the filling) or rotated back toward the connection point with the ends of the ring body.

In another embodiment, the curing light(s) and power source may be integrated into a matrix ring that also has an integrated placement/removal feature (described more fully below).

Restorative material curing lights are most effective when placed <2 mm from the restorative material and aimed directly into the material. The current method of holding the curing light device over the restoration area can be ineffective if not held in exactly the right area for the duration of the cure; the process is very user dependent. By integrating the curing light into the matrix ring would ensure that the curing light is placed at the correct distance and location, without adding any additional steps to the procedure (assuming a matrix ring would already be used).

Integrating the curing function into the matrix ring also simplifies the procedure for the user by reducing the amount of devices needed and reducing clutter in the working area (mouth).

In one embodiment, the tip or body material of the matrix ring, whether plastic, metal, or bulk amorphous alloy, houses the curing light(s) and directs them towards the restoration area. The curing light(s) may then be connected to an external power source, whether battery or plug-in.

In another embodiment, the matrix ring would house both the curing light(s) and the battery power source. The battery could be, but is not limited to, the following technologies: lithium-polymer, lithium-ion, nickel-metal hydride and may be rechargeable, for example, by an inductive based recharging system.

The power source may be integrated into the integrated placement/removal features, along with an activation control placed in an ergonomic location.

Bulk amorphous alloy may be used for the matrix ring and/or housing of the curing light and power source. Bulk amorphous alloy is capable of being cast into the complex geometries required to integrate these devices, while still having the mechanical properties to function as a matrix ring.

Further, the matrix ring may incorporate a reflective structural tip, for example, formed by bulk amorphous alloy, described above, and then over-molded with the light-translucent soft material. The reflective surface may be manufactured with such a finish and geometry as to direct light from a curing light source into the restoration areas. The light-translucent soft material designed such that it allows the curing light to pass through, into the restoration areas. The soft material may also be designed to aim the light.

The reflective surface on this tip design reflects light into the restoration area that may otherwise go to waste passing through an all-clear tip and going to a useless area. This improves the speed & depth of curing by increasing the light directed to the restoration materials.

In addition, the metal substrate of the tip may be designed to have mechanical features aid in bonding to the soft-material.

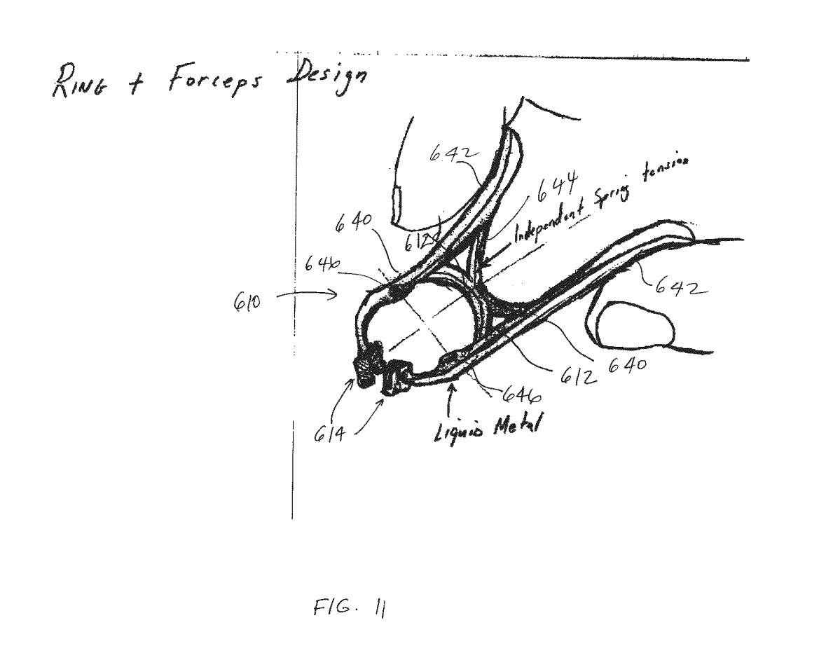

In yet another embodiment, shown in FIG. 11, a matrix ring 610 of the present invention includes forceps, which may be integrally formed or removably attached (including partially removably attached). As best seen in FIG. 11, matrix ring 610 includes an open ring body 612, a pair of arms 640, which are either integrally formed with ring body 612 or joined therewith, and a pair of tips 614, which are mounted or formed at the ends of the ring body 612. When arms 640 are integral with ring body 612, tips 614 may be also integral with the distal ends of arms 640.

Arms 640 project from ring body 612 to form gripping surfaces. In the illustrated embodiment, the distal portions of arms 640 form handles that provide the gripping surface and can be pressed together by a user's fingers to cause the tips to separate. In this manner, arms 640 and handles 642 form built-in forceps. Therefore, matrix ring 610 can provide a matrix ring with integrated features that allow it to be opened, placed, and removed by hand, without the need for any external forceps, or other instruments.

In the embodiment shown, the arms form handles extending away from the tips, which as noted, may be squeezed with finger pressure to open the matrix ring for placement and removal. Arms or handles 640 generally have similar or the same contour as the inwardly curved arms of ring body 612 so that their distal ends are either formed with or adjacent the ends of ring body 612 and therefore also spaced apart but are biased toward each other by ring body 612. Alternately as described above the ends of the ring body, as well as the end of the arms, may touch each other in their nominal position to increase the separation force when the ends are separated.

Arms 640 diverge from ring body 612 such that their distal portions form handles which can be pressed together by a user to spread tips 614 apart for placement of ring body 612 and tips 614 about a tooth under restoration, in a similar manner as described above. To bias distal portions 642 of arms 640 in their home or nominal position, where tips 614 are either contacting each other or are closely spaced, matrix ring 612 further includes a spring 644, for example a generally C-shaped spring, which is mounted between distal portions 642, and further optionally joined with the body 612d of ring body 612. Thus, arms or handles 640 may have an independent spring tension from the spring member of the matrix ring.

In one embodiment, to reduce the size and bulkiness, and further increase the strength and longevity, of the device, matrix ring 610 may be at least primarily or fully made out of bulk amorphous alloy.

A matrix ring with integrated placement/removal features is advantageous to the user, as it eliminates the need for a unique tool that would not otherwise be used in the procedure. This feature would increase the ease and speed of placement and removal. By using a bulk amorphous alloy, this device can have the high strength and high elasticity required, while having a smaller, thinner design. Bulk amorphous alloy also can allow for a simpler, one-material design for the structural component of the device, rather than a plastic and spring steel design.

As noted, the matrix ring and integrated placement/removal feature (arms or handles 640) may be created out of one or more pieces, each made of high strength plastic, metal, or bulk amorphous alloy, all made from a variety of processes.

In one embodiment, one or more components may be high strength, high heat, and corrosion resistant plastic.

In another embodiment, one or more components may be formed from a bulk amorphous alloy. Bulk amorphous alloy's high strength and elasticity may allow for a smaller and stronger design that alternate materials.

Further, tips 614 may be movable and/or removable as described in reference to the earlier embodiments. For further details of tips 614 reference is made to the description of tips 14, 114, 214, 314, 414, and 514 above.

In addition, similar to matrix ring 510, one more or all of the components may be formed from a bulk amorphous alloy which may or may not have a second material, such as a soft material, providing a soft contact face for tips 614.

As would be understood, the spring force exerted by spring 644 is selected so as to make the squeezing of the two handles 642 possible by finger pressure, without the need for any external forceps or other instruments. Further, when made from bulk amorphous alloy, matrix ring 610 may be scaled down from standard matrix rings, and the dimensions of the arms (and hence forceps) may be minimized to allow for relatively easy placement and then removal.

In operation, the dental professional first selects an appropriately sized and shaped matrix ring. It is contemplated that a single matrix ring will generally be suitable for a majority of the population; however, it is also contemplated that a kit may be provided having a plurality of matrix rings, each of which is provided in a different size to correspond to a number of differently sized teeth and relative mouth dimensions. Once selected the dental practitioner or dentist (hereinafter dental professional) installs a matrix band against the tooth that is to be restored. A number of different matrix bands are available commercially, and the present invention is not limited to any particular type of matrix band or configuration of matrix band.

Once positioned, the dental professional next inserts a wedge into the interproximal space, if desired. Subsequently, the dental professional expands the biasing ring, typically with a pair of expanding jaw pliers or the forceps incorporated into the matrix ring described in reference to FIG. 9. Specifically, the dental professional grasps opposing sides of the ring away from the tines and engages the pliers or forceps to separate the opposing tines from each other.

Once the opposing tines have been separated to an extent that the tines can extend on opposing sides of the tooth to be restored and the adjacent tooth, the dental implement is installed into the mouth of the patient. The opposing tines are positioned so that the peak of the wedge extends into the interproximal space between two adjacent teeth, and so that the bottom end of the base is at or near the gum line. The pliers or forceps are then released, so as to gently release the opposing tines.

Further release of the matrix ring from the pliers, further directs the central wedge into the desired position within the interproximal zone. Additionally the front contact surface of the superimposed pad is then directed into contact with the matrix band and/or the tooth surface. The moveable nature of the tips allows for adaptation and uniform engagement on the tooth and/or matrix band.

It should be understood one or more features of one embodiment may incorporated or substitute for features in any of the described embodiments. For example, any of the above matrix rings may be partially or fully formed from a bulk amorphous alloy. In any of the embodiments the tips may be adjustable or removable.

Accordingly, the present invention provides for:

Tip of matrix ring is allowed to pivot about the occlusogingival (vertical) axis.

Amount of pivot is limited (preferred amount of approx. 0-55°)

The tip could be spring loaded (through a spring or material properties) to return to the nominal position when unloaded.

Tip of matrix ring is allowed to swivel about multiple axes.

The motion along some axes may be limited or even prevented.

In an ideal embodiment, the tip has limited motion about the occlusogingival and buccolingual axes, but is fixed about the mesiodistal axis.

The tip could be spring loaded (through a spring or material properties) to return to the nominal position when unloaded.

The tips of the matrix ring may be designed such that they can be removed & replaced.

This may be accomplished via a snap-fit design. The snap fit design may allow for the assembly force to be significantly lower than the disassembly force.

The tips may be designed such that they are able to be assembled & disassembled multiple times.

The tips may be designed such that they are destroyed once they are disassembled.

A matrix ring system with at least two rings, one having a distal leg that is shorter in the occlusogingival direction, the other shorter on the mesial leg.

The shorter leg is designed such that it can be placed above a rubber dam clamp, while still adapting and maintaining to the tooth anatomy.

A matrix ring where the ring body (spring member) attaches to the tip near the gingival margin.

A matrix ring made completely or partially out of a bulk amorphous alloy.

An embodiment with a bulk amorphous alloy ring body (spring member) with integrated tip geometry to engage the teeth, with an added soft material to adapt to the teeth.

An embodiment with a bulk amorphous alloy ring body (spring member) with tips made of at least one additional material, those tips being designed to retain & adapt to the tooth.

An embodiment with a bulk amorphous alloy ring body (spring member) attached to bulk amorphous alloy tips with integrated retention features. This design may or may not have an attached soft material for tooth adaptation.

A matrix ring with integrated features that allow it to be opened, placed, and removed by hand, without the need for any forceps, or other instrument.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

It should be understood one or more features of one embodiment may incorporated or substitute for features in any of the described embodiments. For example, any of the above matrix rings may be partially or fully formed from a bulk amorphous alloy. In any of the embodiments the tips may be adjustable or removable.

The embodiments of the invention in which we claim an exclusive property or privilege are defined as follows:

1. A matrix ring comprising:
a ring body terminating at two spaced apart opposing ends; and
a pair of tips, at least one of said tips movably mounted to one of said ends.

2. The matrix ring of claim 1 wherein at least a portion of said ring body generally lies in a plane, and said tip is movable about at least one axis generally angled with respect to or parallel to said plane.

3. The matrix ring of claim 2 wherein said tip is movable over a limited range of motion about said axis, said limited range of motion being less than 360° about said at least one axis.

4. The matrix ring of claim 3 wherein said limited range of motion is about 0° to 55°.

5. The matrix ring of claim 2 wherein each of said tips is movably mounted to a respective end.

6. The matrix ring of claim 5 wherein said tips are movably mounted about two axes.

7. The matrix ring of claim 1 wherein said tip includes a nominal position, said tip being biased to return to its nominal position when unloaded.

8. The matrix ring of claim 1 wherein each of said ends includes a cylindrical portion, said tip mounted about said cylindrical portion.

9. A matrix ring comprising:
a ring body having two spaced apart opposing ends; and
a tip removably mounted to at least one of said ends by a releasable connection, said releasable connection adapted to allow articulation of said ring body about said tip or articulation of said tip about said ring body.

10. The matrix ring of claim 9 wherein said releasable connection comprises a snap-fit connection.

11. The matrix ring of claim 10 wherein said snap-fit connection comprises at least one stop to limit the articulation of said tip or said ring body.

12. The matrix ring of claim 9 wherein said tip includes a break-away portion when said tip is removed such that said tip cannot be remounted on said ring body.

13. A matrix ring comprising:
a ring body having two spaced apart opposing ends; and
a pair of tips, each top formed or mounted at a respective end of said ring body, at least a portion of said ring body or said tips comprising a bulk amorphous alloy wherein said ring body exhibits the same strength after the ends are opened to 10 mm and released for 500 cycles.

14. The matrix ring of claim 13 wherein said tips have an apex for placement in the interproximal space between teeth, and said ends are joined with said tips offset from apexes.

15. The matrix ring of claim 13 wherein at least a portion of said ring body or tips forms a reflective surface to improve visibility of the working area.

16. The matrix ring of claim 13 wherein said tips are integrally formed at the ends of said ring body and form an anatomically contoured retentive edge.

17. The matrix ring of claim 13 further comprising a pair of soft faces, wherein each of said tips has a back side joined with said ends of said ring body and an outwardly facing side, each of said outwardly facing sides including a mechanical lock to interlock with its respective soft face.

18. A matrix ring comprising:
a metal ring body having two opposing ends; and
a pair of metal arms joined with said ring body and projecting from said ring body to form gripping areas wherein a user may compress said gripping areas to thereby separate said ends.

19. The matrix ring of claim 18 further comprising a tip mounted at each of said ends.

20. The matrix ring of claim 18 wherein at least a portion of said ring body and/or said arms comprises a bulk amorphous alloy.

21. The matrix ring of claim 20 wherein said ring body and said arms comprise a bulk amorphous alloy.

22. The matrix ring of claim 18 further comprising a spring to urge said arms to an uncompressed position.

23. The matrix ring of claim 22 wherein said spring comprises a C-shaped spring between located between said arms.

24. The matrix ring of claim 23 wherein said C-shaped spring in joined with said ring body.

25. The matrix ring of claim 18 wherein said arms have distal portions projecting from said ring body, said distal portions forming handles, said handles including said gripping areas.

26. A matrix ring comprising:
a metal ring body having two opposing ends;
a pair of tips either integrally formed or mounted at said ends; and
a curing light emitting source incorporated into said ring body or in at least one of said tips for curing filling material.

27. The matrix ring of claim 26 further comprising a source of power for powering said curing light emitting source.

28. The matrix ring of claim 26 wherein said source of power is incorporated into said tip or said ring body.

29. The matrix ring of claim 26 wherein said tip includes a soft face.

30. The matrix ring of claim 29 wherein said soft face is transparent or translucent.

31. The matrix ring of claim 26 wherein said curing light emitting source comprises an LED.

32. The matrix ring of claim 29 wherein said curing light emitting source emits light, said light passing through said soft face though an opening or space in said soft face, through a light pipe in said soft face or through a light transmissive portion of said soft face.

33. The matrix ring of claim 26 wherein said curing light emitting source emits light, and at least a portion of said ring body and/or said tip forming a reflective surface to reflect or focus said light in a desired direction.
